(19) United States
(12) Patent Application Publication
(10) Pub. No.: US 2025/0335852 A1
(43) Pub. Date: Oct. 30, 2025

(54) SYSTEM AND METHOD FOR DYNAMIC DATA ACCESS CONTROL AND VERSIONED BRANCH MANAGEMENT IN A COLLABORATIVE DATA ENVIRONMENT

(71) Applicant: PALANTIR TECHNOLOGIES INC., Denver, CO (US)

(72) Inventors: Daniel KOZLOWSKI, NEW YORK, NY (US); Jacob POTTER, GOLDEN, CO (US); Tinlok PANG, NEW YORK, NY (US); Russ GLENN, MUNCHEN (DE); Caleb RICH, DENVER, CO (US); Joseph MAKOWSKI, ARLINGTON, VA (US); Suong DIEC, CUPERTINO, CA (US); Parag SHAH, AUSTIN, TX (US); Alan HSIEH, HILLSBOROUGH, CA (US); Xuefeng BAI, SAN JOSE, CA (US); Clemens WILTSCHE, NEW CASTLE, IN (US)

(21) Appl. No.: 19/189,932

(22) Filed: Apr. 25, 2025

Related U.S. Application Data
(60) Provisional application No. 63/639,511, filed on Apr. 26, 2024.

(51) Int. Cl. G06Q 10/0633; G06F 9/451

(52) U.S. Cl. CPC G06Q 10/0633; G06F 9/451

(57) ABSTRACT

A method and system for collaborative data management within a multi-source data collaboration platform are disclosed. The system receives data objects from various sources through a plurality of Application Programming Interfaces (APIs) and stores them into a system branch. Upon receiving user editorial requests to edit or add data objects, the system forks user branches from the system branch to execute these requests. The graphical user interface (GUI) displays both the system branch and user branches, allowing users to fork additional branches as needed. Prediction results are generated based on data from both the system branch and user branches, enabling users to compare and analyze different sets of predictions. This collaborative approach facilitates efficient data management and analysis, enhancing decision-making processes across multiple users and branches within the platform.

### CROSS REFERENCE TO RELATED APPLICATION

The present application claims priority to and the benefits of U.S. Provisional Application No. 63/639,511, filed on Apr. 26, 2024, which is hereby incorporated by reference in its entirety.

### FIELD OF THE INVENTION

This disclosure relates to a multi-source data collaboration platform involving dynamic branch management and data access control.

### BACKGROUND

Modern organizations rely heavily on data-driven insights to make projections and inform decision-making processes across various domains, such as a meteorological agency providing weather forecast based on data collected from weather stations, satellites, radar systems, and atmospheric models; a utility company seeking to predict electricity consumption to optimize energy generation and distribution based on historical energy usage, weather patterns, time of day, and customer behavior; or a retail company predicting its future sales, revenue, and product demand for upcoming quarters based on currently available data from various third-party sales channels or ecommerce platforms. However, the effective management of large volumes of dynamically changing data sourced from diverse origins presents significant challenges to businesses, particularly in terms of integration, accuracy, scalability, and collaboration.

Traditional methods of data management, often characterized by manual processes and disparate systems, are prone to inefficiencies and errors that can hinder organizational performance and decision-making capabilities. Firstly, users typically obtain their data directly from the source and perform their own analysis. However, when they make local modifications to this data, those changes aren't visible to other users. This lack of transparency makes it difficult for different users to effectively collaborate. For instance, if a first user makes editorial changes, a second user cannot simply utilize the first user's data without directly reaching out to the first user. This results in a cumbersome manual process and potential errors.

Secondly, ensuring that everyone's data remains synchronized and updated from sources is a manual undertaking. If there's an update on data source (a third-party platform), such as an e-commerce store updating its sales figures or a weather service altering its data, these updates must be manually disseminated to users who've requested the data. This places the burden on the third-party platform to track who requires what information.

Additionally, if a user wishes to share their data with others, they must proactively distribute it. However, this can lead to conflicts between versions of the data for the recipients, who then need to navigate how to resolve these conflicts independently.

Furthermore, there's currently no centralized hub for managing everyone's data and analyses. Instead, users must directly engage with each other to request or share data. This decentralized approach makes it challenging to maintain organization and facilitate effective collaboration.

To address these challenges, there is a clear need for an automated data management solution that streamlines processes, enhances data accuracy, scalability, and promotes collaboration across organizational boundaries.

### SUMMARY

A computer-based solution is proposed to address dynamic data access control and versioned branch management within a multi-source data collaboration platform. This environment may involve a server or cloud service responsible for maintaining a primary system branch and accommodating multiple user groups, such as different departments within a company or regional offices. The system branch collects live data from various sources on a consistent basis or according to a predetermined schedule. Users from different groups are permitted to access data from the system branch, make editorial modifications (such as adding new data sources or altering existing data), and utilize models (such as machine learning models trained on historical data) to generate localized predictions. The described methods and systems detail the management of the evolving system branch and user-generated branches, addressing technical challenges including branch management, caching mechanisms, version control, and access control.

In one general aspect, a computer-implemented method may include receiving, through a plurality of Application Programming Interfaces (APIs), data objects from a plurality of data sources. Computer-implemented method may also include storing the data objects into a system branch. The method may furthermore include receiving a user editorial request to edit one of the data objects in the system branch or add a new data object. The method may in addition include forking a first user branch from the system branch and executing the user editorial request in the first user branch. The method may moreover include displaying, on a graphic user interface (GUI), the first user branch and the system branch to users, allowing the users to fork additional user branches from either the system branch or the first user branch. The method may also include generating a first set of prediction result based on the data objects in the system branch, and a second set of prediction result based on data objects in the first user branch. The method may furthermore include displaying the first set of prediction result and the second set of prediction result on the GUI. Other embodiments of this aspect include corresponding computer systems, apparatus, and computer programs recorded on one or more computer storage devices, each configured to perform the actions of the methods.

Implementations may include one or more of the following features. The computer-implemented method may further include receiving a locking command from the first user branch; and synchronizing the first user branch into the system branch by storing the edited data object or the added data object into the system branch.

In some embodiments, the data objects may include immutable data objects and dynamic data objects, where the immutable data objects are locked, and the dynamic data objects may include predictions and subject to further changes.

The computer-implemented method may further include receiving, through the plurality of APIs, updates from the plurality of data sources, where the updates indicate a first dynamic data object in the system branch is updated and becomes a first immutable data object; and broadcasting instructions to all user branches for discarding local changes to the first dynamic data object in the user branches and synchronizing the first dynamic data object as the first immutable data object.

In some embodiments, the forking the first user branch may include: copying a subset of the data objects from the system branch into a cache area corresponding to the first user branch, where the subset of the data objects may include data objects edited by the user editorial request, and other data objects that have timestamps falling in a time window with a predetermined recency.

In some embodiments, the executing the user editorial request in the first user branch may include: applying the user editorial request to the subset of the data objects stored in the cache area to reflect instant effect of the user editorial request in the first user branch.

In some embodiments, the executing the user editorial request in the first user branch further may include: creating a backend process to apply the user editorial request to corresponding data objects stored in an archive system, where the backend process takes longer than applying the user editorial request to corresponding objects in the cache area, where, upon completion of the backend process, the corresponding data objects stored in the archive system are synchronized with the corresponding objects in the cache area.

The computer-implemented method may further include receiving a second user editorial request to edit one of the data objects or stub a new data object in the first user branch; and forking a second user branch from the first user branch and executing the second user editorial request in the second user branch.

The computer-implemented method may further include receiving a second locking command from the second user branch; and synchronizing the second user branch into the first user branch and the system branch.

The computer-implemented method may further include receiving a lock command in the system branch; sending requests to all user branches for locking the user branches; and synchronizing the locked user branches into the system branch to create a snapshot of the system branch.

In some embodiments, the first user branch generates branch snapshots periodically before being locked, allowing users to roll the first user branch backward or forward to any snapshot. Implementations of the described techniques may include hardware, a method or process, or a computer tangible medium.

In one general aspect, a system may include one or more processors and memory storing instructions that, when executed by the one or more processors, cause the system to perform operations having: receiving, through a plurality of Application Programming Interfaces (APIs), data objects from a plurality of data sources; storing the data objects into a system branch; receiving an user editorial request to edit one of the data objects in the system branch or add a new data object; forking a first user branch from the system branch and executing the user editorial request in the first user branch; displaying, on a graphic user interface (GUI), the first user branch and the system branch to users, allowing the users to fork additional user branches from either the system branch or the first user branch; generating a first set of prediction result based on the data objects in the system branch, and a second set of prediction result based on data objects in the first user branch; and displaying the first set of prediction result and the second set of prediction result on the GUI. Other embodiments of this aspect include corresponding computer systems, apparatus, and computer programs recorded on one or more computer storage devices, each configured to perform the actions of the methods.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the technology are utilized, and the accompanying drawings of which:

FIG. 1 illustrates a traditional system for multi-user data consumption and collaboration based on data from various sources.

FIG. 2 illustrates an exemplary system diagram of a multi-source data collaboration platform, in accordance with some embodiments.

FIG. 3A illustrates an exemplary diagram of branch management in the multi-source data collaboration platform, in accordance with some embodiments.

FIG. 3B illustrates an exemplary diagram of locking mechanism in the multi-source data collaboration platform, in accordance with some embodiments.

FIG. 3C illustrates an exemplary diagram of version control in the multi-source data collaboration platform, in accordance with some embodiments.

FIG. 4 illustrates an exemplary diagram of branch display in the multi-source data collaboration platform, in accordance with some embodiments.

FIG. 5 illustrates an exemplary method for the multi-source data collaboration, in accordance with some embodiments.

FIG. 6 illustrates a block diagram of an example computer system in which any of the embodiments described herein may be implemented.

### DETAILED DESCRIPTION

The technology described herein relates to systems and methods for facilitating real-time user collaboration in a multi-source platform. Such platform entails different users creating forecasts or anticipations using data sourced from multiple origins. At times, users might amend a local version of the data or introduce their unique data to refine their individual forecasts or predictions.

There are various real-world scenarios that may involve such platform. For example, medical researchers or research entities accesses data from different hospitals, clinics, and public health agencies to predict disease outbreaks or analyze the effectiveness of certain treatments. Each researcher or research entity may adjust their local copy of the data or incorporate findings from their own studies or experiments to make their customized predictions or projections. These customized predictions or projections may be shared among the researchers or research entities. Some of the local findings, if proven true, may be shared by the researchers or entities as a new data source.

As another example, scientists studying climate change gather data from satellites, weather stations, and environmental sensors worldwide. They use this data to make predictions about future climate patterns, sea level rise, and extreme weather events. Some researchers may supplement the data with their own field observations or experiments to refine their predictions.

As another example, financial analysts from different departments within a company access a centralized platform that collects financial data from various sources such as sales reports, market trends, and economic indicators. Each analyst may apply their own models and algorithms to the data to make projections about future sales, revenue, and market performance. Some analysts may also incorporate local data, such as regional sales figures or customer feedback, to refine their predictions.

Since all the aforementioned real-world applications share similarities in terms of system management and user collaboration, the following description uses a generic multi-source data collaboration platform to cover all these practical applications, and to illustrate the inventive designs to improve the data management and user collaboration among diverse users.

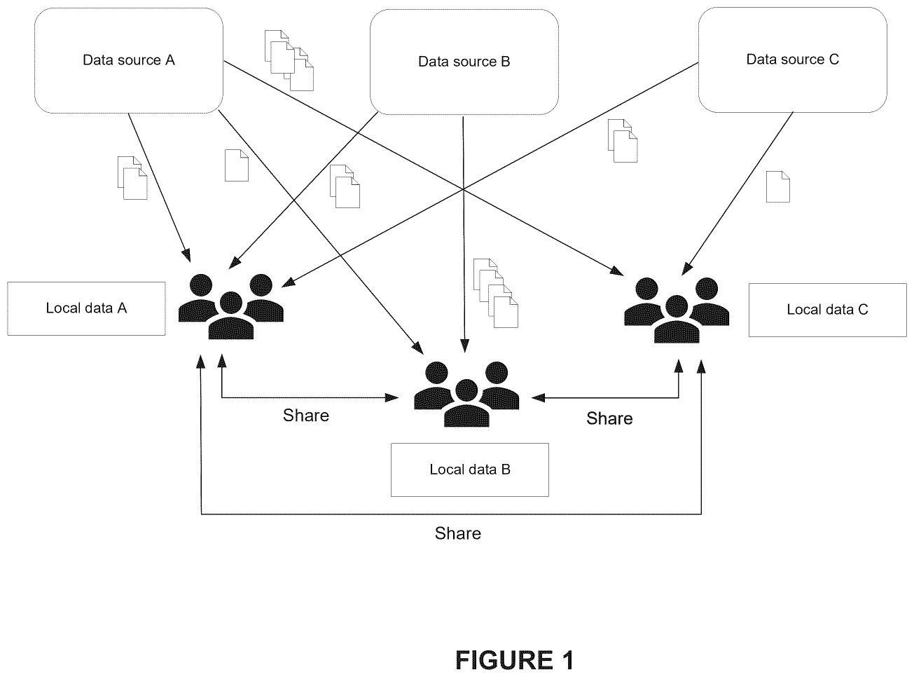

FIG. 1 illustrates a traditional system for multi-user data consumption and collaboration based on data from various sources.

Traditionally, users or user groups collect data from multiple sources for local processing. When these sources use different formats or provide overlapping data, users must perform data transformation or purging to create a local version of the obtained data. After local processing, users may introduce editorial changes, such as adding new data sources or making adjustments. These adjustments collectively are referred to as editorial changes. Subsequently, users may analyze the data using machine learning models to generate projections, which can then be shared with others.

Often, one user's projections based on locally edited data may be valuable to another user who wishes to adopt the data and make further adjustments. This results in a user-to-user sharing scenario. However, in the traditional system depicted in FIG. 1, the second user must first obtain its original dataset from various sources, then acquire the first user's dataset directly from the first user, and finally perform data transformation and/or purging before making local editorial changes and generating projections. This manual process burdens users, leading to inefficiencies and potential errors.

Furthermore, the data sources typically engage in ongoing data collection, followed by actively transmitting new data to users with established connections or by responding to data requests from users who seek to receive new data. Subsequently, these newly acquired data must undergo additional rounds of transformations and purging at each local user or user group. Evidently, this decentralized approach necessitates redundant data processing at the local user level, resulting in inefficiencies.

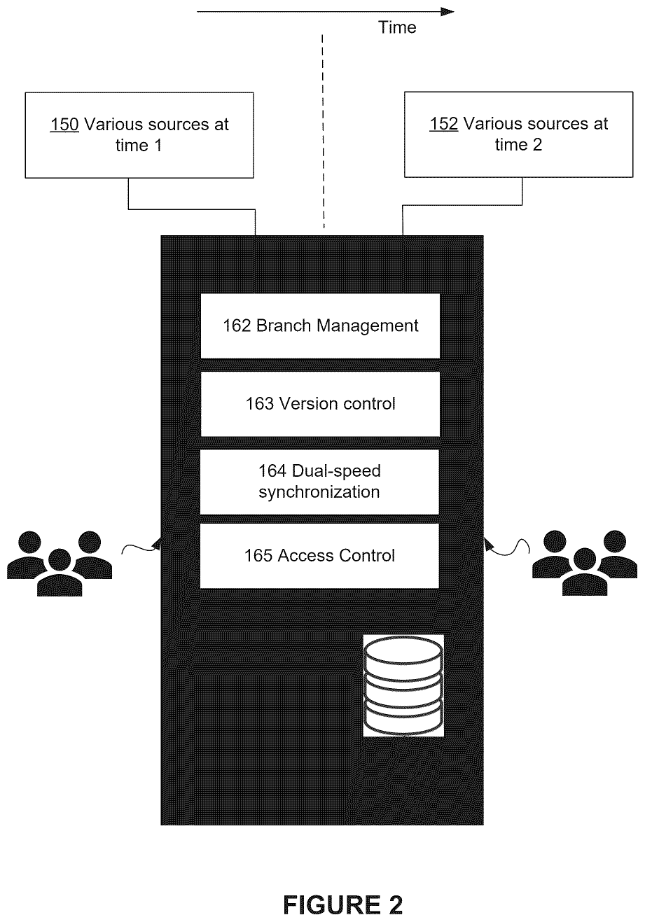

FIG. 2 illustrates an exemplary system diagram of a multi-source data collaboration platform, in accordance with some embodiments. The components of the system 160 in FIG. 2 are for illustrative purposes only. Depending on the implementation, the system 160 may include fewer, more, or alternative components.

In some embodiments, the system 160 may include a branch management module 162, a version control module 163, a dual-speed synchronization module 164, and an access control module 165. In addition to these software-based modules, the system 160 may also include an archive storage device 169 and a cache 168 for storing live mirror system.

The system 160 may further include Application Programming Interfaces (APIs) for fetching or retrieving data from various data sources. The A PI may periodically fetch (actively) or receive (passively) different versions of data from the diverse data sources at different time points 150 and 152.

In some embodiments, the branch management module 162 is designed to oversee the branches within the system 160. These branches typically fall into two categories: a system branch housing data sourced from various outlets, and one or more editorial branches. An “editorial branch” in this context signifies a divergent pathway of development, akin to an alternative reality branching off from the system branch. This setup enables local users to pursue separate modifications, additions, or experiments without directly influencing the system branch.

Additionally, the branch management module 162 facilitates the creation of a second editorial branch by another local user, stemming from a first user's editorial branch. At inception, the second editorial branch mirrors the content of the first editorial branch. Subsequently, the second local user gains the ability to manipulate data, introduce new data sources, establish snapshots, and navigate through the second editorial branch's timeline, advancing or regressing to newer or older versions as necessary.

Here, the “add new sources of data” refers to the action of “stubbing” in the context of software development, which includes creating placeholder implementations or mock data objects in an editorial branch. These mock data objects are not yet fully materialized or integrated into the branch. Stubbing new data sources allows the users to simulate the data prediction/projection behavior with the newly introduced dependencies. In some embodiments, the stubbing may trigger creation of duplicates once backing data (e.g., the placeholder implementations or mock data objects) have been fully materialized. In some embodiments, alerts may be generated when such duplicates are created or predicted to be created, and/or automatic deduplication procedures may be generated.

For example, a user who has forked an editorial branch may become aware of a new data source not present in the system branch. In response, the user may stub the new data source by introducing a set of new data objects within the editorial branch. These stubbed data objects retain a dynamic quality and may be discarded or subjected to further alterations as needed. Once the user is confident that the new data source has been fully materialized, the system 160 permits the user to lock the stubbed data objects. Upon locking, these data objects become immutable, meaning they cannot be modified or updated thereafter.

The branch management module 162 facilitates the forking of an editorial branch (referred to as the second editorial branch) by a second local user from an existing editorial branch belonging to a first local user (referred to as the first editorial branch). Upon forking, the second editorial branch is created as an identical mirror copy of the first editorial branch. Subsequently, the second local user gains the ability to modify data, stub new data sources, generate snapshots, and navigate the timeline of the second editorial branch by rolling it forward or backward to access newer or older versions, respectively.

In some embodiments, each of the editorial branches may be used to generate localized or customized projections based on the local data in the editorial branch. For example, consider a scenario where the system branch holds sales or revenue data for a manufacturer sourced from various third-party sales platforms, such as ecommerce platforms. A regional team, operating within a specific country or continent, may create an editorial branch derived from the system branch. Subsequently, they might modify certain sales or revenue data points based on their local insights. This could involve adjusting projections to reflect delays in payment, even if a sale contract has been executed in the current quarter. Additionally, the regional team may possess data unavailable from third-party platforms, such as offline sales from local channels. In such cases, the team can introduce these unique data sources into their editorial branch, enhancing the accuracy of their projections.

When forking an editorial branch from its parent branch, whether it's the system branch or another editorial branch, a mirror copy of the parent branch is typically created in the cache 168. However, due to the potentially large volume of data in the parent branch, the process of copying the entire parent branch may be time-consuming and resource-intensive in terms of cache space. In certain embodiments, to mitigate this issue, the mirror copy for the editorial branch may selectively copy only a subset of data objects from the parent branch. This subset typically includes data objects with timestamps falling within a predetermined recency window, such as those from the past 3 days or the previous week or month. This selective copying strategy is based on the understanding that recent data objects are more likely to undergo changes compared to older ones. By focusing on recent data, the creation of the editorial branch is expedited as only the essential data is copied. Moreover, this approach minimizes the cache footprint for each editorial branch, thereby enabling the system 160 to accommodate a larger number of parallel editorial branches without overburdening the system resources.

In some embodiments, the initiation of an editorial branch can be triggered either through user interaction with the system's A PI or by directly modifying the data objects within the system branch. For instance, the system 160 may offer a range of APIs enabling users to fork new branches from a base branch, such as the system branch or an existing editorial branch, for editorial modifications. These A PIs may provide users with options to specify permissions for the new branch, such as allowing stubbing new data sources, editing existing data objects, enabling other users to use the new branch as a base for further forks, and defining access permissions or other suitable configurations.

Alternatively, when a user interacts with data objects within the system branch and attempts to modify one, the system 160 could automatically initiate the forking process to create an editorial segment from the system branch. Any alterations made by the user may be temporarily stored in a staging area within the cache 168 until the editorial branch is fully established. Once the editorial branch is generated, the user's modifications can be applied to the designated data object and then cleared from the staging area. This method offers an advantage over the A PI-triggered approach by avoiding situations where a user initiates an editorial branch through the A PI but makes no subsequent alterations to any data objects. By dynamically creating editorial branches only when necessary changes are made, this approach helps prevent unnecessary consumption of cache space.

In some embodiments, the system 160 may maintain a graphic user interface (GUI) displaying the active (existing) branches in the system, including the system branch and one or more editorial branches. When displaying the editorial branches, each branch is displayed as a timeline. All the local changes to the editorial branches are also displayed as nodes on the timeline, so that other users may view the changes and make additional changes in their editorial branches.

In certain cases, a user may generate a new editorial branch based on more than one existing branches (e.g., one system branch and one or more editorial branches, or more than one editorial branches). When there are more than one base branches, the system 160 may first merge the more than one base branches into an intermediate branch by deduplicating the overlapping data and adding the non-overlapping data. When the more than one base branches have conflicting data objects (e.g., the same object from the system branch is edited in editorial branch), the system 160 may present the conflict in a multi-column user interface for the user to manually merge the conflicting data objects.

The editorial branch users may generate their respective data projections based on the data objects in their respective branches. These projections may also be displayed on the GUI, providing a transparent view of the different realities from different users.

In some embodiments, the version control module 163 of the system 160 is configured to keep track the changes made to each of the branches and generate branch snapshots for the changes, thereby allowing branch users to roll back to an earlier version of the branch, or in some cases roll forward to a later version of the branch (typically happens after a rolling-back occurs). In order to minimize the storage footprint, the snapshots are generated as incremental snapshots instead of full snapshots. For instance, the snapshot at time t+1 only records the changes from the snapshot at t that were made by the user between time t and time t+1. The tradeoff here is that in order to rollback to branch to a target snapshot, incremental snapshots require all the previously stored snapshots to be loaded into the memory in order to reconstruct the branch state corresponding to the target snapshot.

In some embodiments, after an editorial branch is forked, the user of the editorial branch may make changes to the branch. The changes may be grouped and stored as snapshots. On each editorial branch, the snapshots may be displayed on the GUI as nodes on the editorial branch, facilitating the user to review the changes and/or revert to certain snapshots by simply selecting the corresponding nodes.

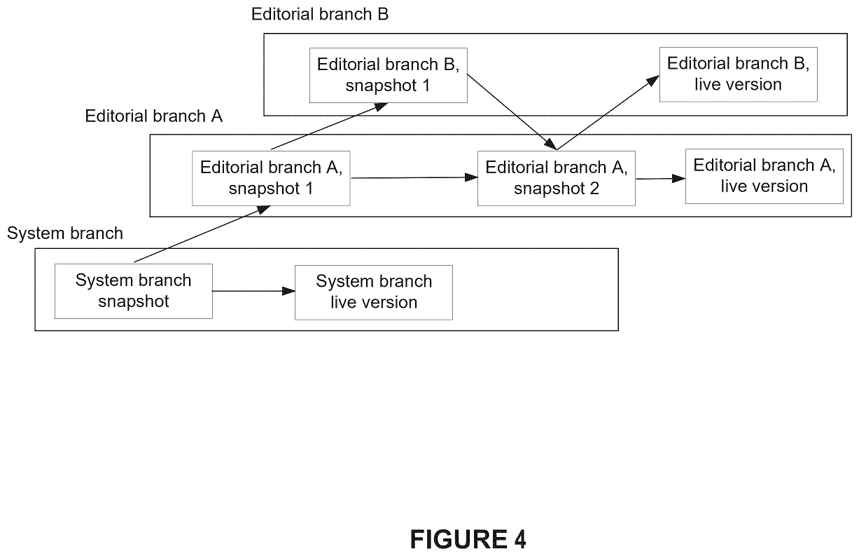

In some embodiments, cross-branch snapshot adoption may be implemented. Here, the “cross-branch snapshot adoption” refers to an editorial branch adopts a snapshot from another branch after the editorial branch is initialized. For example, a first editorial branch may adopt a snapshot from a second editorial branch, and apply the corresponding changes that have had occurred in the second editorial branch up to the point of the snapshot. This may require both editorial branches to be originated/forked from the same base branch (e.g., the system branch or another editorial branch). The cross-branch snapshot adoption may effectively merge the two editorial branches at the point of the snapshot. On the GUI, the two editorial branches may share the node corresponding to the snapshot, e.g., the two branches intersect at the node corresponding to the snapshot, then diverge again into two branches. More details are described in FIG. 4.

In some embodiments, the dual-speed synchronization module 164 facilitates the use of distinct data channels within the system to promptly reflect user's editorial modifications in real-time while also asynchronously storing these alterations in the archive system located in the backend. For instance, when a user initiates changes to an editorial branch, these modifications are directly applied to the live mirror system residing in the cache 168. This mechanism enables the editorial branch to promptly showcase the user's changes on the GUI, enabling other users to observe and potentially adopt these alterations in real-time.

Concurrently, the system 160 may initiate a backend process to asynchronously propagate these modifications to the archive system stored in 169. Although the cache 168 exclusively retains a subset of the data contained in 169, it encompasses the data objects from a recent timeframe, which are more prone to user edits. Consequently, the “faster” data channel leading to the cache 168 provides real-time visibility of changes with minimal latency, while the “slower” data channel ensures that these alterations are securely and asynchronously preserved in long-term storage media.

In some embodiments, the access control module 165 may be configured to operate on a row-level permissioning model, where access to individual data rows is governed by specific attributes or properties associated with each row. Users are assigned attributes based on their roles, responsibilities, and affiliations, allowing the system to tailor access permissions accordingly. For example, the access control is enforced through intersection calculations, where the system compares a user's attributes with the properties of each data row. Only when there is a 100% match between the user's attributes and the row's properties is access granted. This stringent requirement ensures precise control over data visibility, mitigating the risk of unauthorized access and data breaches.

The system's granularity enables fine-tuned access control over data objects, with users only able to view data relevant to their roles and responsibilities. This dynamic data visibility enhances security and confidentiality, particularly in environments where sensitive information is involved. Additionally, the system 160 accommodates diverse access needs, distinguishing between reporting and operational views to support both external reporting requirements and internal decision-making processes.

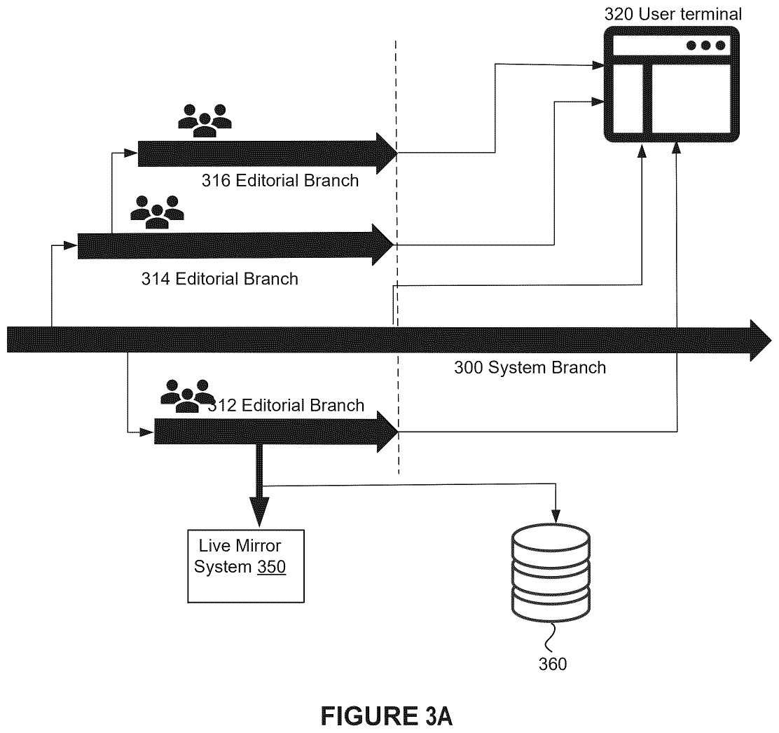

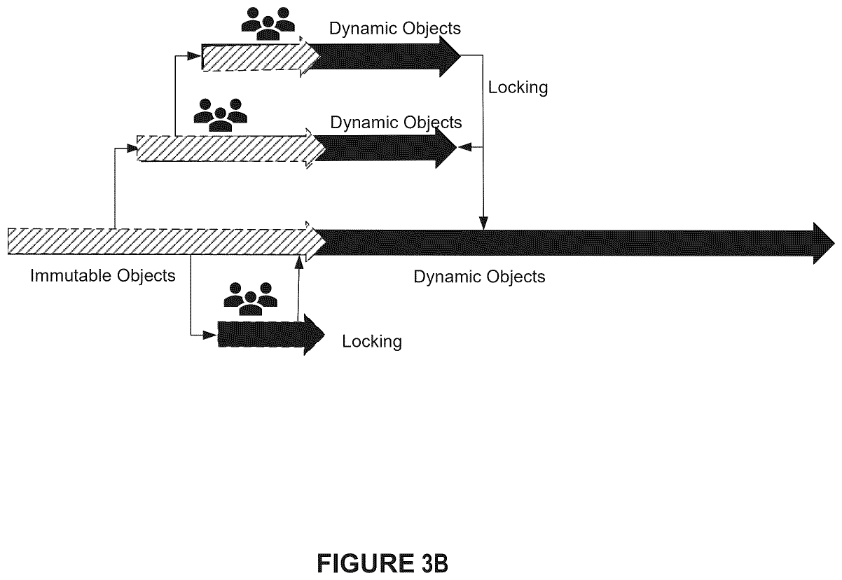

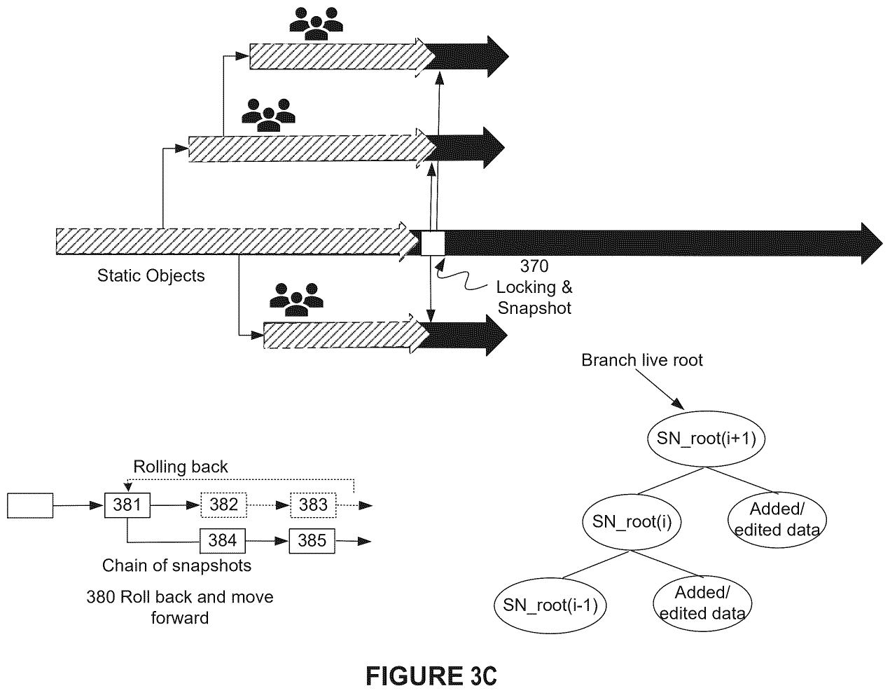

FIG. 3A illustrates an exemplary diagram of branch management in the multi-source data collaboration platform, in accordance with some embodiments. This diagram, building upon the concepts described in FIG. 2, illustrates the management of various types of branches.

In some embodiments, the system branch 300 in FIG. 3A is configured to be the main branch storing the data obtained directly from the various data sources. These sources may include third-party entities tasked with collecting data on behalf of the owner of the system branch. For example, a manufacturing company may distribute its products to third-party retailers for online sales, in-store transactions, wholesale purposes, and more. These retailers gather sales data related to the products, which is then forwarded back to the manufacturer for consolidation and analysis, such as predicting future product demand.

Users associated with the system branch 300 have the capability to create editorial branches, exemplified by branches 312, 314, and 316 in FIG. 3A, derived from the system branch 300. These users could represent different regional offices of the entity that owns the system branch 300. Editorial branches can be initiated directly from the system branch 300, as seen with branches 312 and 314, or forked from existing editorial branches, as demonstrated by branch 316 derived from branch 314. Users are empowered to modify existing data within their editorial branches or introduce new data sources as needed.

Upon the creation of an editorial branch, a live mirror system 350 of the base branch is generated and stored in a cache to facilitate real-time user feedback. The base branch refers to the originating branch from which the editorial branch is forked. The live mirror system 350 comprises a subset of data objects extracted from the base branch to minimize cache utilization. This subset includes data objects altered by the user's editorial actions and those within a time window of predetermined recency, such as the most recently created data objects. In some instances, a reserved cache space is allocated for the editorial branch upon its creation, ensuring adequate storage for initializing the branch's data objects.

The primary objective of caching the data objects from the editorial branch is to furnish users with instantaneous feedback. User-initiated editorial changes are applied to the cached data objects, thereby reflecting immediate updates within the editorial branch. To ensure data synchronization across the system, changes to the data objects are also gradually propagated to the archive storage 360 through a backend process. This backend process operates at a slower pace compared to applying user edits to the cached data objects, establishing a dual-speed synchronization process.

In some embodiments, each editorial branch leads to a customized projection generated from the edited data objects within the branch. These customized projections can be visualized on the graphical user interface (GUI) of a user terminal 320, alongside the editorial branches represented as a sequence of nodes. Each node signifies the alterations made within the editorial branch, enabling users to trace the trajectory of data changes leading to specific projections. This visualization method enhances the transparence of the data evolution within the system.

FIG. 3B illustrates an exemplary diagram of locking mechanism in the multi-source data collaboration platform, in accordance with some embodiments. The locking mechanism is designed to lock a certain branch (either the system branch or the editorial branches) so that the changes made prior to the locking operation become permanent.

In some embodiments, various types of locking mechanisms exist, such as system branch locking and editorial branch locking. System branch locking may occur at predetermined intervals, such as weekly, monthly, or quarterly. When the system branch is locked, the current live version of the branch is frozen into a snapshot, signifying that all preceding changes are solidified, and the data objects within the system branch become immutable. Subsequent to locking, new data objects may still be stored into the live version of the system branch, but modifications to the locked data objects are prohibited. Nonetheless, the system branch may offer APIs (Application Programming Interfaces) for system users to revert to a specific snapshot from a previous timepoint. This rollback functionality effectively restores the system branch to a previous version. Such a mechanism serves as a recourse for the system branch in the event of inaccuracies or malicious alterations within the locked data.

In some embodiments, following the locking of a system branch, the locked data objects may undergo synchronization with co-existing editorial branches, resulting in the transformation of mirror copies of the data objects within the editorial branches into immutable entities. Essentially, the locking of a system branch may extend to the derivative editorial branches, rendering them locked as well.

Additionally, a user operating within an editorial branch may initiate a locking operation on the branch. For example, upon confirmation of the validity of stubbed data objects (provisional additions of new data sources) and local modifications within the editorial branches, the user may choose to lock the editorial branch, thereby solidifying these changes. If the editorial branch serves as the base from which other editorial branches are derived, the derivative branches may also undergo locking, ensuring that the copied data objects become immutable.

FIG. 3C illustrates an exemplary diagram of version control in the multi-source data collaboration platform, in accordance with some embodiments. The version control manages the data changes occurred within each branch.

As described in FIG. 3B and illustrated in FIG. 3C, when a branch undergoes a locking operation, a snapshot of the branch is generated (370). These snapshots comprise a sequence that empowers the branch to revert or advance to a designated snapshot. Upon rolling back the branch to an earlier snapshot, any subsequent modifications to the branch result in the creation of a fresh timeline.

Illustrated in scenario 380 of FIG. 3C, the branch is rolled back to snapshot 381 from its live version, followed by the generation of new snapshots 384 and 385 due to subsequent changes or locking operations. Here, the “live version” of a branch denotes the branch's current state, including dynamic data objects that have not been included in any snapshot yet. However, in contrast to conventional version control mechanisms (which removes the older timeline completely), the older timeline of the branch remains intact; snapshots 382 and 283 are retained rather than removed. This preservation enables the branch to revert to any of the snapshots within the old timeline, such as 283 and 383. The rolling back process may include reverting the branch from the new live version back to snapshot 381, and then applies the changes between snapshots 381, 382, and 383 to restore the old timeline.

In some embodiments, the existing data sources (e.g., the third-party entities collecting data) may update the data objects in the system branch through A PIs provided by the system. The update may transform a dynamic data object into an immutable data object (e.g., a licensing agreement is materialized after negotiation). Upon receiving such updates, the system branch proceeds to lock the data objects within its branch, subsequently broadcasting the update to the editorial branches for synchronization. In some cases, certain editorial branches may have already made local edits to the data object. Consequently, the broadcasted request may include instructions for the editorial branches to discard these local changes and synchronize with the immutable version present in the system branch.

FIG. 4 illustrates an exemplary diagram of branch display in the multi-source data collaboration platform, in accordance with some embodiments. The diagram in FIG. 4 is to illustrate the display of multiple branches that involve cross-branch snapshot adoption.

As shown, Editorial Branch A comprises Snapshot 1 and Snapshot 2, while Editorial Branch B stems from Editorial Branch A. Specifically, Editorial Branch B may be initialized as a replicated version of Snapshot 1 in Editorial Branch A. Throughout the lifespan of Editorial Branch B, Snapshot 2 from Editorial Branch A can be incorporated via cross-branch snapshot adoption, as outlined in the description of FIG. 2. Consequently, the visual representation of the branches may indicate that Editorial Branch A and Editorial Branch B intersect at Snapshot 2 of Editorial Branch A before diverging again into two distinct editorial branches. This visual cue serves to inform other users that the snapshot at the intersection of the two branches is shared.

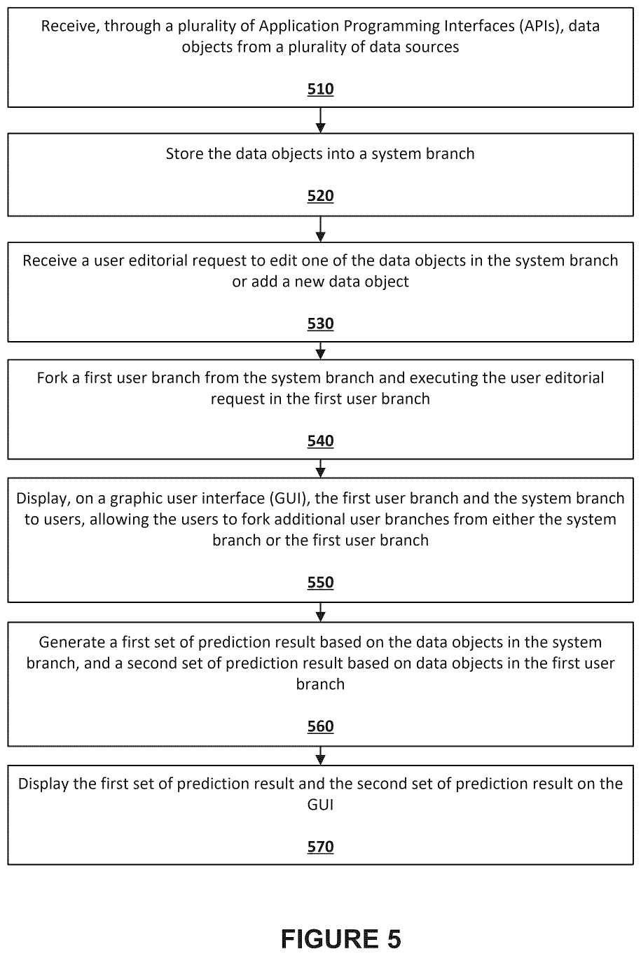

FIG. 5 illustrates an exemplary method 500 for the multi-source data collaboration, in accordance with some embodiments. In some implementations, one or more process blocks of FIG. 5 may be performed by a system.

As shown in FIG. 5, process 500 may include receiving, through a plurality of Application Programming Interfaces (APIs), data objects from a plurality of data sources (block 510). For example, the system may receive, through a plurality of application programming interfaces (APIs), data objects from a plurality of data sources, as described above. As also shown in FIG. 5, process 500 may include storing the data objects into a system branch (block 520).

For example, the system may store the data objects into a system branch, as described above. As further shown in FIG. 5, process 500 may include receiving a user editorial request to edit one of the data objects in the system branch or add a new data object (block 530). For example, the system may receive a user editorial request to edit one of the data objects in the system branch or add a new data object, as described above. As also shown in FIG. 5, process 500 may include forking a first user branch from the system branch and executing the user editorial request in the first user branch (block 540). For example, the system may fork a first user branch from the system branch and executing the user editorial request in the first user branch, as described above.

As further shown in FIG. 5, process 500 may include displaying, on a graphic user interface (GUI), the first user branch and the system branch to users, allowing the users to fork additional user branches from either the system branch or the first user branch (block 550).

For example, the system may display, on a graphic user interface (GUI), the first user branch and the system branch to users, allowing the users to fork additional user branches from either the system branch or the first user branch, as described above.

As also shown in FIG. 5, process 500 may include generating a first set of prediction result based on the data objects in the system branch, and a second set of prediction result based on data objects in the first user branch (block 560). For example, the system may generate a first set of prediction result based on the data objects in the system branch, and a second set of prediction result based on data objects in the first user branch, as described above.

As further shown in FIG. 5, process 500 may include displaying the first set of prediction result and the second set of prediction result on the GUI (block 570). For example, the system may display the first set of prediction result and the second set of prediction result on the GUI, as described above.

Process 500 may include additional implementations, such as any single implementation or any combination of implementations described below and/or in connection with one or more other processes described elsewhere herein. A first implementation, process 500 further includes receiving a locking command from the first user branch; and synchronizing the first user branch into the system branch by storing the edited data object or the added data object into the system branch.

In a second implementation, alone or in combination with the first implementation, the data objects may include immutable data objects and dynamic data objects, where the immutable data objects are locked, and the dynamic data objects may include predictions and subject to further changes.

A third implementation, alone or in combination with the first and second implementation, process 500 further includes receiving, through the plurality of APIs, updates from the plurality of data sources, where the updates indicate a first dynamic data object in the system branch is updated and becomes a first immutable data object; and broadcasting instructions to all user branches for discarding local changes to the first dynamic data object in the user branches and synchronizing the first dynamic data object as the first immutable data object.

In a fourth implementation, alone or in combination with one or more of the first through third implementations, the forking the first user branch may include: copying a subset of the data objects from the system branch into a cache area corresponding to the first user branch, where the subset of the data objects may include data objects edited by the user editorial request, and other data objects that have timestamps falling in a time window with a predetermined recency.

In a fifth implementation, alone or in combination with one or more of the first through fourth implementations, the executing the user editorial request in the first user branch may include: applying the user editorial request to the subset of the data objects stored in the cache area to reflect instant effect of the user editorial request in the first user branch.

In a sixth implementation, alone or in combination with one or more of the first through fifth implementations, the executing the user editorial request in the first user branch further may include: creating a backend process to apply the user editorial request to corresponding data objects stored in an archive system, where the backend process takes longer than applying the user editorial request to corresponding objects in the cache area, where, upon completion of the backend process, the corresponding data objects stored in the archive system are synchronized with the corresponding objects in the cache area.

A seventh implementation, alone or in combination with one or more of the first through sixth implementations, process 500 further includes receiving a second user editorial request to edit one of the data objects or stub a new data object in the first user branch; and forking a second user branch from the first user branch and executing the second user editorial request in the second user branch.

An eighth implementation, alone or in combination with one or more of the first through seventh implementations, process 500 further includes receiving a second locking command from the second user branch; and synchronizing the second user branch into the first user branch and the system branch.

A ninth implementation, alone or in combination with one or more of the first through eighth implementations, process 500 further includes receiving a lock command in the system branch; sending requests to all user branches for locking the user branches; and synchronizing the locked user branches into the system branch to create a snapshot of the system branch.

In a tenth implementation, alone or in combination with one or more of the first through ninth implementations, the first user branch generates branch snapshots periodically before being locked, allowing users to roll the first user branch backward or forward to any snapshot.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

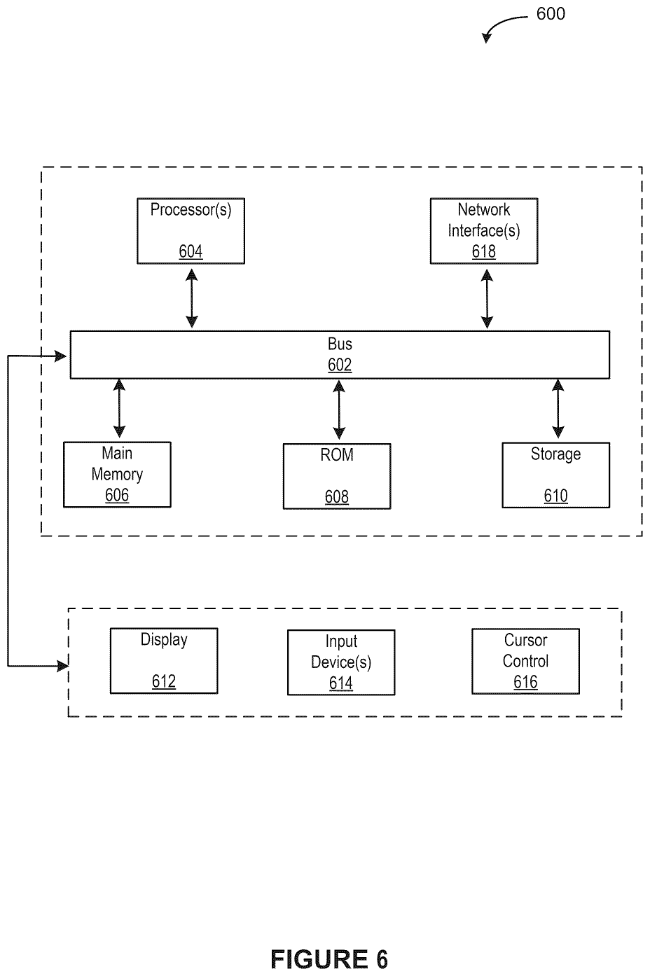

FIG. 6 illustrates a block diagram of an example computer system 600 in which any of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a cathode ray tube (CRT) or LCD display (or touch screen), for displaying information to a computer user. An input device 616, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 606 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 606 retrieves and executes the instructions. The instructions received by main memory 606 may retrieves and executes the instructions. The instructions received by main memory 606 may optionally be stored on storage device 610 either before or after execution by processor 606.

The computer system 600 also includes a communication interface 618 coupled to bus 602. Communication interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN (or WAN component to communicated with a WAN). Wireless links may also be implemented. In any such implementation, communication interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet”. Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 606 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method, comprising:
receiving, through a plurality of Application Programming Interfaces (APIs), data objects from a plurality of data sources;
storing the data objects into a system branch;
receiving a user editorial request to edit one of the data objects in the system branch or add a new data object;
forking a first user branch from the system branch and executing the user editorial request in the first user branch;
displaying, on a graphic user interface (GUI), the first user branch and the system branch to users, allowing the users to fork additional user branches from either the system branch or the first user branch;
generating a first set of prediction result based on the data objects in the system branch, and a second set of prediction result based on data objects in the first user branch; and
displaying the first set of prediction result and the second set of prediction result on the GUI.

2. The computer-implemented method of claim 1, further comprising:
receiving a locking command from the first user branch; and
synchronizing the first user branch into the system branch by storing the edited data object or the added data object into the system branch.

3. The computer-implemented method of claim 1, wherein the data objects comprise immutable data objects and dynamic data objects, where the immutable data objects are locked, and the dynamic data objects comprise predictions and subject to further changes.

4. The computer-implemented method of claim 1, wherein the forking the first user branch comprises:
copying a subset of the data objects from the system branch into a cache area corresponding to the first user branch, wherein the subset of the data objects comprise data objects edited by the user editorial request, and other data objects that have timestamps falling in a time window with a predetermined recency.

5. The computer-implemented method of claim 4, wherein the executing the user editorial request in the first user branch comprises:
applying the user editorial request to the subset of the data objects stored in the cache area to reflect instant effect of the user editorial request in the first user branch.

6. The computer-implemented method of claim 4, wherein the executing the user editorial request in the first user branch further comprises:
creating a backend process to apply the user editorial request to corresponding data objects stored in an archive system, wherein the backend process takes longer than applying the user editorial request to corresponding objects in the cache area,
wherein, upon completion of the backend process, the corresponding data objects stored in the archive system are synchronized with the corresponding objects in the cache area.

7. The computer-implemented method of claim 1, further comprising:
receiving a second user editorial request to edit one of the data objects or stub a new data object in the first user branch; and
forking a second user branch from the first user branch and executing the second user editorial request in the second user branch.

8. The computer-implemented method of claim 7, further comprising:
receiving a second locking command from the second user branch; and
synchronizing the second user branch into the first user branch and the system branch.

9. The computer-implemented method of claim 1, further comprising:
receiving a lock command in the system branch;
sending requests to all user branches for locking the user branches; and
synchronizing the locked user branches into the system branch to create a snapshot of the system branch.

10. The computer-implemented method of claim 3, further comprising:
receiving, through the plurality of APIs, updates from the plurality of data sources, wherein the updates indicate a first dynamic data object in the system branch is updated and becomes a first immutable data object; and
broadcasting instructions to all user branches for discarding local changes to the first dynamic data object in the user branches and synchronizing the first dynamic data object as the first immutable data object.

11. The computer-implemented method of claim 1, wherein the first user branch generates branch snapshots periodically before being locked, allowing users to roll the first user branch backward or forward to any snapshot.

12. A system for reducing failure rates of a manufactured product comprising:
one or more processors; and
memory storing instructions that, when executed by the one or more processors, cause the system to perform operations comprising:
receiving, through a plurality of Application Programming Interfaces (APIs), data objects from a plurality of data sources;
storing the data objects into a system branch;
receiving a user editorial request to edit one of the data objects in the system branch or add a new data object;
forking a first user branch from the system branch and executing the user editorial request in the first user branch;
displaying, on a graphic user interface (GUI), the first user branch and the system branch to users, allowing the users to fork additional user branches from either the system branch or the first user branch;
generating a first set of prediction result based on the data objects in the system branch, and a second set of prediction result based on data objects in the first user branch; and
displaying the first set of prediction result and the second set of prediction result on the GUI.

13. The system of claim 12, wherein the operations further comprise:
receiving a locking command from the first user branch; and
synchronizing the first user branch into the system branch by storing the edited data object or the added data object into the system branch.

14. The system of claim 12, wherein the forking the first user branch comprises:
copying a subset of the data objects from the system branch into a cache area corresponding to the first user branch, wherein the subset of the data objects comprise data objects edited by the user editorial request, and other data objects that have timestamps falling in a time window with a predetermined recency.

15. A non-transitory computer readable medium comprising instructions that, when executed, cause one or more processors to perform operations comprising:
receiving, through a plurality of Application Programming Interfaces (APIs), data objects from a plurality of data sources;
storing the data objects into a system branch;
receiving a user editorial request to edit one of the data objects in the system branch or add a new data object;
forking a first user branch from the system branch and executing the user editorial request in the first user branch;
displaying, on a graphic user interface (GUI), the first user branch and the system branch to users, allowing the users to fork additional user branches from either the system branch or the first user branch;
generating a first set of prediction result based on the data objects in the system branch, and a second set of prediction result based on data objects in the first user branch; and
displaying the first set of prediction result and the second set of prediction result on the GUI.

16. The non-transitory computer readable medium of claim 15, wherein the operations further comprise:
receiving a locking command from the first user branch; and
synchronizing the first user branch into the system branch by storing the edited data object or the added data object into the system branch.

17. The non-transitory computer readable medium of claim 15, wherein the forking the first user branch comprises:
copying a subset of the data objects from the system branch into a cache area corresponding to the first user branch, wherein the subset of the data objects comprise data objects edited by the user editorial request, and other data objects that have timestamps falling in a time window with a predetermined recency.

18. The non-transitory computer readable medium of claim 17, wherein the executing the user editorial request in the first user branch comprises:
applying the user editorial request to the subset of the data objects stored in the cache area to reflect instant effect of the user editorial request in the first user branch.

19. The non-transitory computer readable medium of claim 17, wherein the executing the user editorial request in the first user branch further comprises:
creating a backend process to apply the user editorial request to corresponding data objects stored in an archive system, wherein the backend process takes longer than applying the user editorial request to corresponding objects in the cache area,
wherein, upon completion of the backend process, the corresponding data objects stored in the archive system are synchronized with the corresponding objects in the cache area.

20. The non-transitory computer readable medium of claim 15, the operations further comprising:
receiving a lock command in the system branch;
sending requests to all user branches for locking the user branches; and
synchronizing the locked user branches into the system branch to create a snapshot of the system branch.
